(19) United States
(12) Patent Application Publication
(10) Pub. No.: US 2006/0188771 A1
(43) Pub. Date: Aug. 24, 2006

(54) Fuel cell stack compression assembly

(75) Inventors: Jeffrey Peter Allen, Naugatuck, CT (US); Peter Wilcox Allen, Southbury, CT (US); James L. Ouellette, Terryville, CT (US)

Correspondence Address: BANNER & WITCOFF, LTD., 28 STATE STREET, 28th FLOOR, BOSTON, MA, 02109-9601, US

(73) Assignee: GenCell Corporation, Southbury, CT (US)

(21) Appl. No.: 11/354,207

(22) Filed: Feb. 14, 2006

Related U.S. Application Data
(60) Provisional application No. 60/652,653, filed on Feb. 14, 2005.

(51) Int. Cl. H01M 8/02; H01M 8/24

(52) U.S. Cl. 429/37; 429/38

(57) ABSTRACT

A compression assembly for use with a fuel cell stack is disclosed. The compression assembly includes opposing end plate manifolds, thermal insulation layers, cold compression plates and compression distribution plates. The compression distribution plates include a plurality of extension elements that are connected and in a manner to provide compressive force to the fuel cell stack.

### RELATED U.S. APPLICATON(S)

This application claims the benefit of U.S. Provisional Application No. 60/652,653 filed on Feb. 14, 2005 and entitled “Fuel Cell Stack Compression Assembly,” the entire disclosure of which is hereby incorporated herein by reference for all purposes.

### FIELD OF THE INVENTION

This invention relates to fuel cell stacks and to methods and apparatus for the application of compressive load to opposing ends of fuel cell stacks and to methods of mounting fuel cell stacks.

### BACKGROUND

Fuel cells are electrochemical devices that produce direct electric current and thermal energy. Fuel cell stacks generally include a plurality of fuel cells stacked in a series relationship to achieve higher useable voltage output capacities. Fuel cell stacks are terminated at each end with end plate assemblies. The end plate assemblies are generally equipped by way of tie-rods and plates to apply a compressive load to the fuel cell stack for the purpose of achieving a low electronic contact between the layers of the individual cells as well as to provide a sealing force to contain the reactants within the fuel cell stack. This system that applies the compressive load may be referred to in the art as a “compression assembly.” Further, fuel cell stacks are generally fastened to a support structure that permits the installation of the fuel cell into a system that processes the reactants and products of the fuel cell and controls the overall safety of the system.

Fuel cells are generally identified by the type of electrolyte that is used. For example, molten carbonate fuel cells (MCFCs) may use a mixture of lithium carbonate and potassium carbonate as the electrolyte. Phosphoric acid fuel cells (PAFCs) may use phosphoric acid solutions as an electrolyte. Polymer electrolyte fuel cells (PEFCs) may use a polymer such as Nafion®, a product of Dupont de Nemours Corporation, as an electrolyte. Solid oxide fuel cells (SOFCs) may use a yittria-stabilized zirconia as an electrolyte.

The differing chemistries of the various electrolytes that comprise the field of fuel cell types all require operational temperatures at varying degrees above ambient. For example, SOFC's operate at from about 650° C. to above 1000° C. while PEFC's operate at from about 80° C. to about 150° C. The remaining types of fuel cells generally operate at temperatures between these two types of fuel cells. All fuel cells generate heat and direct current (DC) electrical power as reaction products of the fuel and oxidant within the active zones of the fuel cell.

The product DC power is transmitted to external loads through positive and negative terminals associated with the end plates at the ends of the fuel cell stack. The product heat is used to maintain the fuel cell at the operating temperature appropriate for its respective electrolyte. Excess heat is removed from the fuel cell by coolant flowing through the fuel cell, by flow of reactants through the fuel cell, by transmitting the heat through a heat conductive bus to an external heat sink, or some combination of these methods. Excess heat may be utilized to perform useful work such as maintaining the operating temperature of the system within which the fuel cell is functioning, heating of room air, heating water, or heating of some industrial process.

The process of heat generation and heat removal typically does not occur uniformly throughout the fuel cell. As a result, thermal gradients are generated along both the vertical and horizontal axis of the fuel cell stack. These thermal gradients produce differential thermal expansions and contractions along these axes that can create non-uniform compression of the fuel cell stack due to inflexibility of the stack compression assembly. The intensity and location of the thermal gradients of the fuel cell will vary as the operating conditions of the fuel cell are varied. This results in an ever-changing environment of differential thermal expansions and contractions that can materially affect the performance of the fuel cell. Furthermore, the physical tolerances that exist within the dimensions of the individual cells of the fuel cell stack at the point of manufacture may accumulate in a manner that produces non-parallelism of the major surfaces of the end cells of the fuel cell stack, which can be disadvantageous when applying and maintaining a uniform compressive load to the fuel cell stack. Also, the constant application of compression to the fuel cell stack over the lifetime operation of the fuel cell stack at its elevated operating temperature results in mechanical creep that alters the physical dimensions of the fuel cell stack. The result is that the stack becomes shorter over time. The creep may not occur uniformly due to temperature gradients in the fuel cell or due to non-symmetrical physical construction of the fuel cell or due to other electrochemical effects. The effects of the accumulated tolerances, differential thermal expansions and contractions and the mechanical creep are increased as the area of the fuel cell is increased. Fuel cell area directly affects the current output capacity of the fuel cell and, therefore, can be relatively large for fuel cells intended to produce high power-output capacities.

In general, compression assemblies of the prior art have not been entirely effective in absorbing dimensional non-uniformities caused by stack differential thermal expansions and contractions, accumulated tolerances of the fuel cell stack, and mechanical creep. Also, compression assemblies of the prior art have generally not effectively provided the ability to universally mount the fuel cell in a manner that minimally impacts the compression assembly's ability to uniformly apply a compressive load to the fuel cell stack. There is a need in the art for an apparatus to universally mount and more uniformly compress a fuel cell stack.

It is an object of the present invention to provide an apparatus and methods to more uniformly apply a compressive load to a fuel cell stack. It is a particular object of certain examples or embodiments to provide methods and apparatus to universally mount and more uniformly compress a fuel cell stack.

### SUMMARY OF THE INVENTION

Embodiments of the present invention are directed to compression assemblies for use with fuel cells and to fuel cells incorporating compression assemblies. According to one embodiment, a fuel cell includes a fuel cell stack and a compression assembly. The compression assembly includes a first section at a first end of the fuel cell stack and a second section at a second end of the fuel cell stack with the first section and the second section being connected by a plurality of connection elements so as to provide force to the fuel cell stack. The first section includes in series a first end plate manifold operatively coupled to the fuel cell stack, a first section of thermal insulation, a first cold compression plate and a first compression distribution plate. The second section included in series an opposing end plate manifold operatively connected to the fuel cell stack, an opposing layer of thermal insulation, an opposing cold compression plate and an opposing compression distribution plate. Each compression distribution plate included a plurality of extension elements extending outwardly from a central unitary section and substantially parallel to one another, and with the connection elements connecting respective extension elements of the first compression distribution plate and the opposing compression distribution plate in a manner to produce force between the compression distribution plates and to the fuel cell stack. According to one embodiment of the present invention, the extension elements of the compression distribution plates are independently flexible and may extend beyond the fuel cell stack.

Embodiments of the present invention also relate to a method of providing force to a fuel cell stack including flexibly securing a plurality of extension elements attached to compression plates positioned at opposite ends of a fuel cell stack with each extension element flexibly responding to changes in physical forces within the fuel cell stack. The force applied by the compression plates to the fuel cell stack is variable in response to changes in physical forces within the fuel cell stack.

A compression assembly according to certain embodiments of the present invention used to compress a fuel cell stack includes the following main components in series relationship: end plate manifolds, thermal insulation layers, cold compression plates and compression distribution plates mechanically coupled by a plurality of connection elements which in certain embodiments can be tie rods. Additional or multiple components the same or different, if desired, can be positioned between and/or in addition to the main components. According to one embodiment, the compression assembly is configured to uniformly compress a fuel cell or a fuel cell stack. End plate manifolds are positioned at each end of the fuel cell stack and are operatively connected to the fuel cell stack in a manner to convey reactants to internal manifolds of the fuel cell stack. In addition to those known in the art, examples of suitable end plate manifolds are described in PCT/US04/00886 entitled “Fuel Cell End Plate” hereby incorporated by reference in its entirety for all purposes.

Thermal insulation is used to retain the thermal energy generated by the fuel cell and to isolate the hot fuel cell stack from the components of the compression assembly that are designed to function at ambient or near-ambient temperature. According to one embodiment of the present invention, a layer of thermal insulation is positioned adjacent to the end plate manifold and in some embodiments is placed directly adjacent to the end plate manifold such that the thermal insulation contacts the end plate manifold. However, it is to be understood that the thermal insulation need not directly contact the end plate manifold, but the thermal insulation should be positioned within the compression assembly to achieve thermal insulation of the fuel cell. One or more layers of thermal insulation can be used according to certain aspects of the invention. The thermal insulation generally will be co-extensive with whole or part of the surface of the end plate manifold. Thermal insulation materials for use in fuel cells are known to those of skill in the art and include FLEXIPORE, a product of Porextherm Dammstoffe GmbH and other high purity refractory fibers such as ceria and alumina fiber insulations for high temperature applications as well as silicone-based insulations for low temperature applications.

Cold compression plates are used to transmit the compression forces from the compression distribution plates to the end plate manifolds and through the thermal insulation. The cold compression plates are also configured to deflect or bend an amount sufficient to respond to the differential thermal expansions, accumulated tolerances and mechanical creep of the fuel cell stack while uniformly transmitting the compression forces. According to one embodiment of the present invention, a cold compression plate is positioned adjacent to the layer of thermal insulation and in some embodiments is placed directly adjacent to the layer of thermal insulation such that the cold compression plate contacts the thermal insulation. However, it is to be understood that the cold compression plate need not directly contact the thermal insulation, but the cold compression plate should be positioned within the compression assembly to transmit the compression forces from the compression distribution plates to the end plate manifolds. One or more cold compression plates can be used according to certain aspects of the invention. The cold compression plates generally will be co-extensive with whole or part of the surface of the thermal insulation. Cold compression plate materials for use in fuel cells are known to those of skill in the art and include low carbon steel such as ASTM A514 and 6061 aluminum alloy as well as high temperature polymers such as polysulfone, polyethersulfone and polytetrafluoroethylene.

Compression distribution plates are used to transmit the tensile forces generated by the tie-rods to the cold compression plates. The compression distribution plates are further configured to deflect or bend an amount sufficient to respond to the differential thermal expansions, accumulated tolerances of the fuel cell stack and mechanical creep while uniformly transmitting the tensile forces. Compression distribution plates can be fashioned from materials known to those of skill in the art. According to one embodiment of the present invention, the compression distribution plate includes a plurality of extension elements extending from a central unitary section of the compression distribution plate. Respective ends of the extension elements on upper and lower compression distribution plates are fixedly connected by tie rods. The extension elements can have any suitable geometry, and according to one embodiment of the present, the extension elements are configured as extending beams which operate as leaf-springs. The extension elements are attached to a central, spine-like, strip of material that binds the individual leaf springs together. The compression distribution plate may be fashioned from a unitary piece of material or alternatively the extension elements may be fixedly attached to a central unitary section. Individual extension elements may deflect independent of one another in response to the differential thermal expansions, accumulated tolerance and mechanical creep of the fuel cell yet remain a cohesive element suitable for attachment of mounting systems that fasten the fuel cell within the frame work of an operating system. The thickness and width of the extension elements of the opposing compression distribution plates are configured to deflect without permanent yield of the material of construction in response to the tensile force applied by the tie rods. The sum of the deflections of the two opposing compression distribution plates is selected to be greater than the total expected differential thermal expansions, accumulated tolerance and mechanical creep of the fuel cell stack so that the compression force applied by the compression assembly does not vary significantly from the total compression force applied to the fuel cell stack at the point of assembly or at the point of completion of the initial conditioning of the fuel cell stack. According to one embodiment, the amount of the total expected stack differential thermal expansions, accumulated tolerance and mechanical creep is equal to or less than 10% and preferably equal to or less than 5% of the total compression force applied to the fuel cell stack at the point of assembly or at the point of completion of the initial conditioning of the fuel cell stack.

Connection elements within the scope of the present invention include tie-rods which are attached to the opposing extension elements of the compression distribution plates and are configured to safely generate tensile force to motivate the compression assemblies towards one another to compress the fuel cell stack. Suitable tie rod assemblies are known to those of skill in the art.

In accordance with another aspect, a support structure that permits the installation of the fuel cell into a framework is attached to one of or both of the compression distribution plates, preferably at the central unitary section in a manner that allows the ability of the extension elements of the compression distribution plates to deflect in the manner intended. In a preferred embodiment, the fastening method utilizes a three-point attachment and utilizes fasteners of the type known by those skilled in the art to provide the requisite safety and strength. Ideally, the fastening method should be independent of the orientation of the fuel cell so as to provide the system designer with the maximum flexibility to position the fuel cell stack within the network of piping and enclosures so as to achieve efficiency of system packaging. From a structural viewpoint, the compression distribution plates provide desirable mounting points due to its strength and rigidity relative to other components of the fuel cell stack. The points of attachment and the fuel cell's orientation must be selected so as to minimally impact the compression assembly's ability to uniformly apply a compressive load to the fuel cell stack.

In accordance with another aspect, individual tie-rods may be equipped with a spring device that provides sprung travel to the tie rods to contribute to the amount of sprung deflection of the extension elements of the compression distribution plates to further provide the ability to maintain a constant, or near-constant, compression force to the fuel cell stack. The spring devices may be configured with an indicator or gauge to measure, and optionally to display, the amount of tensile force that is being generated.

In accordance with another aspect, all of the elements of the compression assembly are designed to function with a variable length fuel cell such as the fuel cell described in U.S. Pat. No. 6,670,069 hereby incorporated in its entirety by reference for all purposes. As such the compression assembly disclosed herewith is scalable in the variable dimension of the fuel cell stack. That is, the compression assembly may be constructed longer or shorter without altering its performance capability.

It will be recognized by the person of ordinary skill in the art, given the benefit of this disclosure, that the compression assembly apparatus and methods of use provides numerous advantages including, but not limited to, maintaining a substantially uniform compression to an operating fuel cell or fuel cell stack and to provide more effective mounting methods for fuel cells and fuel cell stacks.

### BRIEF DECRIPTION OF THE DRAWINGS

The aspects of the invention will become apparent upon reading the following detailed description in conjunction with the accompanying drawings, in which:

FIG. 1 is a side view of a fuel cell stack.

FIG. 2 is a plan view of a compression assembly for a fuel cell stack.

FIG. 3 is a cross-section taken along line AA of FIG. 1.

FIG. 4 is a cross-section taken along line BB of FIG. 1.

FIG. 5 is a cross-section taken along line CC of FIG. 2.

FIG. 6 is an elevation view of a fuel cell stack and supporting structure.

The figures referred to above are not drawn necessarily to scale and should be understood to present a representation of the invention, illustrative of the principles involved. Some features of apparatus depicted in the drawings have been enlarged or distorted relative to others to facilitate explanation and understanding. Methods and apparatus for the application of compressive load to opposing ends of fuel cell stacks as disclosed herein, will have configurations and components determined, in part, by the intended application and environment in which they are used.

### DETAILED DESCRIPTION OF THE INVENTION

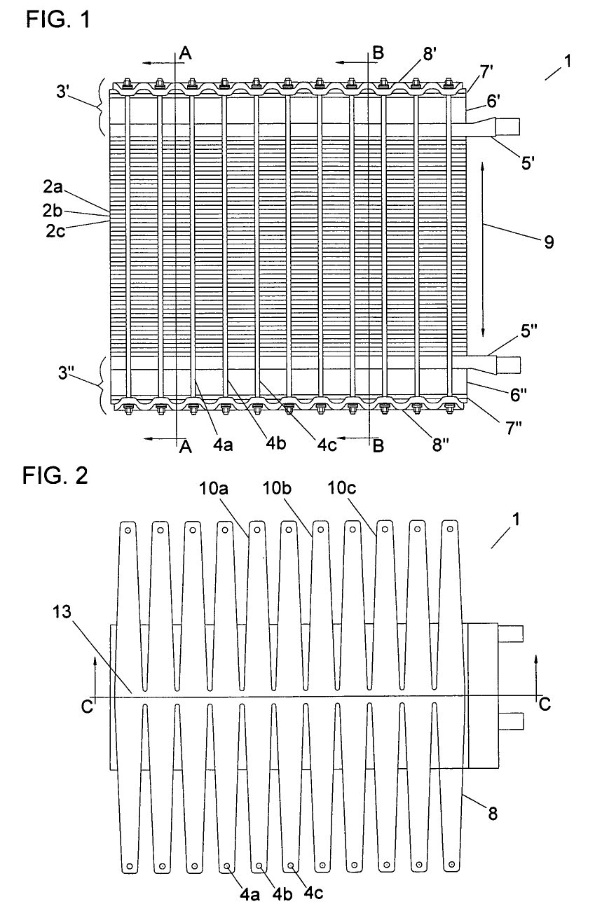

FIG. 1 illustrates a fuel cell stack 1 such as a fuel cell stack described by U.S. Pat. No. 6,670,069 incorporated herein in its entirety by reference. The fuel cell stack 1 is comprised of a plurality of individual cells 2a, 2b, 2c stacked upon one another. Proper functioning of the individual cells 2a, 2b, 2c requires that they be maintained in intimate and uniform contact at the mating faces of each cell. Uniform contact is typically maintained with the application of opposing compressive loads applied to the axial ends of the fuel cell stack 1 by opposing compression assemblies 3′, 3″ mechanically coupled by a plurality of tie rods 4a, 4b, 4c. Compression assembly 3′ includes end plate manifold 5′, such as the end plate manifold described U.S. patent application Ser. No. 10/755,722 incorporated in its entirety by reference, thermal insulation 6′, compression plate 7′ and compression distribution plate 8′.

During assembly and operation of the fuel cell stack 1, various forces combine to distort the dimensions of the plurality of individual cells 2a, 2b, 2c comprising the fuel cell stack 1. The intensity of these forces may vary in different areas of the fuel cell stack 1 resulting in the accumulation of significant distortions at the opposing ends of the fuel cell stack that are adjacent compression assemblies 3′, 3″. The end plates 5′, 5″ are designed to flexibly accommodate the accumulated distortions of the fuel cell stack 1 as described in the cited '722 application. The thermal insulation 6′, 6″ is inherently capable of flexibly accommodating the accumulated distortions of the fuel cell stack 1. The material of construction and the thickness of the compression plates 7′, 7″ are selected so as to flexibly accommodate the accumulated distortions of the fuel cell stack 1. The compression distribution plates 8′, 8″ are designed to uniformly transfer the tensile force 9 applied by the plurality of tie rods 4a, 4b, 4c to the compression plates 7′, 7″. The material of construction and the thickness of the compression distribution plates 8′, 8″ are further designed to deflect a specific distance in response to the tensile force 9. The sum of the deflection of the two opposing compression distribution plates 8′, 8″, in response to the tensile force 9, is selected to be sufficiently greater than the expected maximum distortion of fuel cell stack 1 so that the tensile force 9 will not vary greater than 10% as the compression assemblies 3′, 3″ respond to the distortions of the fuel cell stack 1. The deflection of the compression distribution plates 8′, 8″, in response to the tensile force 9, is further selected to be sufficiently below the yield point for the material comprising the compression distribution plates 8′, 8″ so as to avoid permanent yield of the compression distribution plates 8′, 8″.

FIG. 2 illustrates a plan view of the fuel cell stack 1 where it is seen that the compression distribution plate 8 is configured to include a plurality of extension elements examples of which are represented by 10a, 10b, and 10c and a central unitary section 13. Examples of attachment points for tie rods are shown at 4a, 4b, and 4c. According to one embodiment, the compression distribution plate can be fashioned from a unitary piece of metal with sections removed to create the extension elements while retaining a portion of the unitary piece of metal to form the central unitary section. Extension elements are referred to herein as “leafs” or “leaf spring like elements” or simply “leaf springs.” The extension elements are capable of flexing independent of one another and in response to variations in forces and of distortions of the fuel cell stack 1.

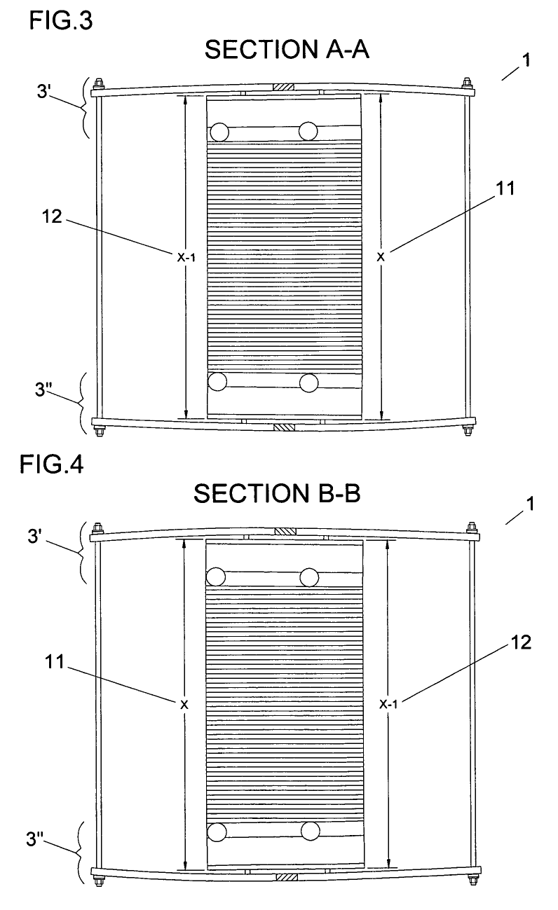

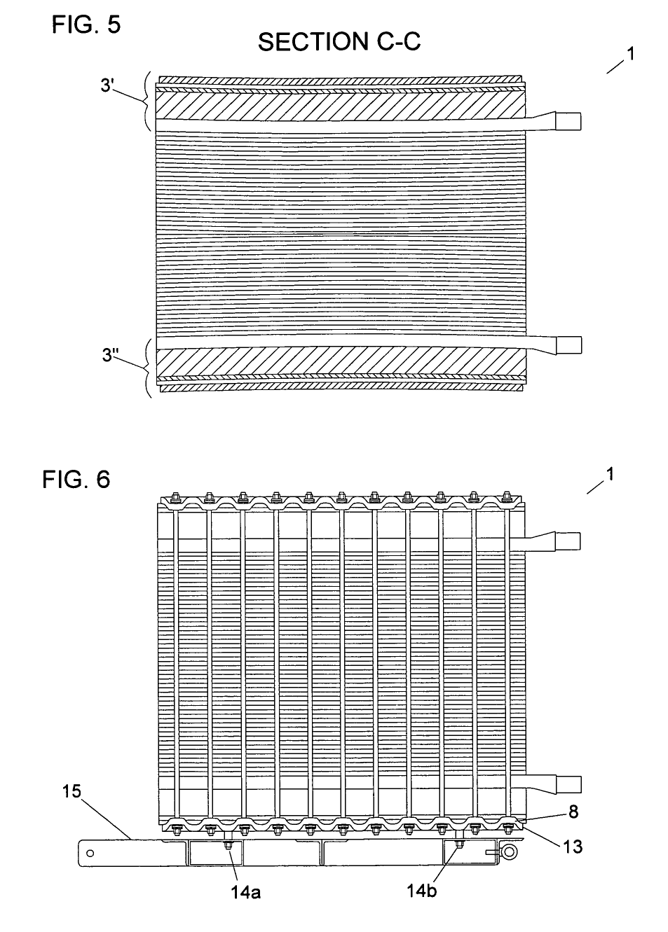

FIGS. 3, 4 and 5 illustrate the accumulated distortions of the fuel cell stack 1 and the response of the compression assemblies 3′, 3″. FIG. 3 illustrates that the dimension 11 of the fuel cell stack 1 is equivalent to X and that distortions have accumulated on an opposing face of the fuel cell stack 1 to reduce the dimension 12 of the fuel cell stack 1 to X-1. FIG. 4 illustrates a similar distortion in an opposite direction occurring at another point along the fuel cell stack 1.

The central unitary section 13 of compression distribution plate 8 is sufficiently rigid to receive a plurality of attachment points 14a and 14b that fasten the fuel cell stack 1 to support structure 15 as shown in FIG. 6.

1. A fuel cell comprising:
a fuel cell stack and a compression assembly,
the compression assembly comprising a first section at a first end of the fuel cell stack and a second section at a second end of the fuel cell stack with the first section and the second section being connected by a plurality of connection elements so as to provide force to the fuel cell stack;
the first section including in series a first end plate manifold operatively coupled to the fuel cell stack, a first section of thermal insulation, a first cold compression plate and a first compression distribution plate;
the second section including in series an opposing end plate manifold operatively connected to the fuel cell stack, an opposing layer of thermal insulation, an opposing cold compression plate and an opposing compression distribution plate;
each compression distribution plate including a plurality of extension elements extending outwardly from a central unitary section and substantially parallel to one another, and with the connection elements connecting respective extension elements of the first compression distribution plate and the opposing compression distribution plate in a manner to produce force between the compression distribution plates and to the fuel cell stack.

2. The fuel cell of claim 1 wherein the extension elements of the compression distribution plates are independently flexible.

3. The fuel cell of claim 1 wherein the extension elements extend beyond the fuel cell stack.

4. The fuel cell of claim 1 wherein the compression distribution plates include mounting sections for mounting the fuel cell to a support structure.

5. The fuel cell of claim 1 wherein the connection elements are tie rods fixedly connected to opposing extension elements.

6. The fuel cell of claim 1 wherein the connection elements include a spring device.

7. A method of providing force to a fuel cell stack comprising flexibly securing a plurality of extension elements attached to compression plates positioned at opposite ends of a fuel cell stack with each extension element flexibly responding to changes in physical forces within the fuel cell stack.

8. The method of claim 7 wherein the force applied by the compression plates to the fuel cell stack is variable in response to changes in physical forces within the fuel cell stack.

9. The method of claim 8 wherein deflection of the extension elements is greater than 5% of total compressive force applied to the fuel cell stack.

10. The method of claim 8 wherein deflection of the extension elements is greater than 10% of total compressive force applied to the fuel cell stack.

11. The method of claim 8 wherein the deflection of springs within the tie rods contributes to the sprung-travel of the extension elements.
